(19) United States
(12) Patent Application Publication
(10) Pub. No.: US 2020/0093120 A1
(43) Pub. Date: Mar. 26, 2020

(54) FRAGRANCE SET TO DETER MARTENS, ESPECIALLY A FRAGRANCE PENDANT

(71) Applicant: KUNAGONE SPOLKA AKCYJNA, Chelmek (PL)

(72) Inventor: Artur OLEJNICZAK, Chelmek (PL)

(21) Appl. No.: 16/495,840

(22) PCT Filed: Mar. 20, 2018
(86) PCT No.: PCT/PL2018/000031

§ 371 Date: Sep. 20, 2019

(30) Foreign Application Priority Data
Mar. 20, 2017 (PL) P.420905

(51) Int. Cl. A01M 29/12; A01N 63/10

(52) U.S. Cl. CPC A01M 29/12; A01N 63/10

(57) ABSTRACT

The subject matter of the invention is a fragrance set to deter martens, especially a fragrance pendant, in particular to deter beech martens (Martes foina) from cars in the garage. The fragrance set to deter martens, especially the fragrance pendant, has a container with through channels, preferably an organza pouch or a drawpiece with a sling, preferably insulated with an outer removable cover made of foil, containing at least two carriers of fragrance, preferably in the form of a polymer, and is characterized in that the hopper (1) has fragrance carriers (2), which are the fibers (3) of the mammalian coat, excrements (4) of predatory animals and/or mixtures thereof, preferably with wax, oil, polyacrylamide gel, most preferably with the addition of a capsaicin solution in the form of oleoresin. Favourably, the carrier (2) of fragrance is the fiber (3) of the dog's fur and/or human hair.

The subject of the invention is a fragrance set, especially a fragrance pendant for marten, in particular to deter beech marten from cars in the garage.

There are known from the commercial offer fragrance pendants in organza-type bags containing flower petals or other porous prills sprayed with fragrances.

There are known from the commercial offer electronic devices emitting ultrasounds for deter marten. There are known from the commercial offer pendants in plastic containers containing deodorant.

The object of the invention is to develop a fragrance set for deter animals, especially marten destroying car wires and insulation in attics of houses.

The essence of the invention is a container with fragrance carriers that are hair fibers of mammals, extrements of predatory animals and/or mixtures thereof, preferably with wax, with an oil, a polyacrylamide gel, most preferably with the addition of a capsaicin solution in the form of oleoresin. Preferably, the aroma carrier is dog hair fibers and/or human hair, most preferably in a ratio of ⅔ of canine hair and ⅓ of human hair. Optional the mixture of aroma carriers are dog hair fibers and human hair, preferably in a ratio of 2.5 dkg of dog hair, 1 dkg of human hair and 2 cm³ of wax, preferably paraffin or stearic mixed in 2% by weight with capsaicin. Preferably a mixture carriers fragrance contains 1÷3 cm³ of wax mixed with 2÷4% by weight 3-methyl butyric acid.

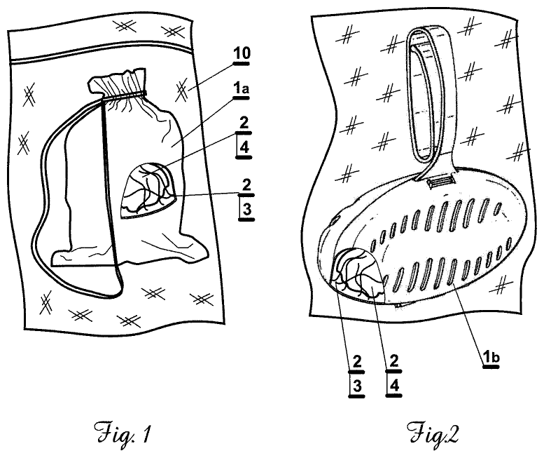

The solution is shown in the drawing, in which FIG. 1 shows a view of the set fragrance in the form of a organza bag filled with fragrance carriers, and FIG. 2 shows a pendant in the form of a plastic molding filled with carriers smell.

Unexpectedly, it turned out that crops close to forest complexes can be protected, because forest animals such as wild boar or roe deer also avoid entering the area, around which the fragrance kits according to the invention are suspended.

For a better explanation of the solution according to the utility model, the following is described solution with the indication of signs used in the drawing.

The fragrance set has a container 1 with through channels, preferably in a form organ bag 1a or extrudate 1b with a plastic sling which made of matching convex parts pressed against the edges and forming the inner chamber. Tray 1 is insulated with an external removable cover from heat-shrinkable foil, in a foil bag with a zip or closure under the vacuum. Optionally, the tray 1 is packed in a sealed cardboard box or a paper envelope with a sealing layer (for example, waxed paper, cardboard lacquered or coated with polyethylene) or in a plastic container plastic. The kit contains at least two fragrance carriers, preferably one in the form of a polymer. The carriers 2 of the fragrances are fibers 3 of the mammalian hair coat, extrements 4 of predatory animals and/or mixtures thereof, preferably with a wax, oil, gel polyacrylamide, most preferably with the addition of capsaicin solution in the form of oleoresin.

Preferably, the aroma carrier 2 is dog hair fibers 3 fur and/or human hair, most preferably in the ratio of ⅔ of dog hair and ⅓ of human hair. Optionally a mixture of carriers 2 of fragrance are dog hair fibers 3 and human hair, preferably in a 2.5 dkg ratio dog hair, 1 dkg of human hair and 2 cm³ of wax, preferably paraffin or stearic mixed in 2% by weight with capsaicin.

Preferably a mixture of carriers 2 of the fragrance contains 1÷3 cm3 of wax mixed with 2÷4% by weight of 3-methyl butyric acid, whose smell is close to the smell of man.

Solutions have been implemented in several examples below, which, however they do not exhaust all possible combinations of components of the invention specific part of claim 1.

### EXAMPLE I

The fragrance set was made in the form of a bag 1a from the organza tied with a string acting as a sling, insulated for storage and transport, external a removable cover of foil 10 in the form of a vacuum-packed bag in which two fragrance carriers were placed. The fragrance carriers 2 used were dog hair fibers 3 and human hair, in the ratio of ⅔ of the dog's hair and ⅓ of human hair 2 cm3 of paraffin wax was sprayed onto this mixture.

Optionally, the hair fiber 3 filament was sprayed with a mixture of molten wax with 2% capsaicin.

### EXAMPLE II

The fragrance set was made in the form of 1a organza bag, insulated with an external one a removable cover of heat-shrinkable foil 10 for storage and transport, wherein two fragrance carriers 2 are placed. Fragrance carriers 2 used were the fibers 3 of dog's hair and human hair, in a ratio of ⅔ dog hair and ⅓ human hair. They are flooded in the technological process with a melted 2 cm3 mixture of wax paraffin with 2% capsaicin.

### EXAMPLE III

The fragrance set was made in the form of a plastic extrudate 1b with a sling, externally insulated with a removable cover of foil 10 in the form of a blister for storage and transport. The kit contains fragrance carriers 2 in the extrudate 1b, which are hair of human, extrements 4 of predators and paraffin wax in weight ratio 3:2:2.

### EXAMPLE IV

The fragrance set was made in the form of a plastic extrudate 1b with a sling, externally insulated with a removable cover of foil 10 closed in a vacuum, for storage and transport. The kit contains fragrance carriers 2 in the extrudate 1b, which are human hair, extrements 4 of predators, paraffin wax and paraffin oil with capsaicin in a 3:2:1:1 weight ratio with paraffin oil mixed in a proportion 9:1 with capsaicin.

### Example V

The fragrance set was made in the form of a plastic extrudate 1b with a sling, externally insulated with a removable cover of foil 10 closed in a vacuum, for storage and transport. The kit contains fragrance carriers 2 in the extrudate 1b, which are 3 dkg of human hair and 3 ml of paraffin wax mixed with 4% of 3-methyl butyric acid (by weight). After applying the perfume set according to the invention in the garage and attic of the buildings no traces of kun were found, previously seen in the vicinity of these buildings.

1. Fragrance set, especially fragrance pendant for marten, has a container with through channels, preferably an organza pouch or a drawpiece with a sling, preferably insulated with an outer removable film sheath, comprising at least two fragrance carriers, preferably in the form of a polymer, characterized in that it has in a container (1) carriers (2) of fragrance, which are the fibers (3) of the mammalian coat, extrements (4) of predatory animals and I or mixtures thereof, preferably with a wax, oil, polyacrylamide gel, most preferably with the addition of capsaicin solution in the form of oleoresin.

2. A kit according to claim 1, characterized in that the fragrance carrier (2) is a hair fiber (3) a dog and I or human hair, preferably in a ratio of ⅔ of canine hair and ⅓ of human hair.

3. A kit according to claim 1, characterized in that the mixture of fragrance carriers (2) there are fibers (3) of dog hair and human hair, preferably in the ratio of 2.5 dkg of dog hair, 1 dkg of human hair and 2 cm³ of wax, preferably paraffin or stearic mixed in 2% by weight with capsaicin.

4. A kit according to claim 1, characterized in that the mixture of fragrance carriers (2) contains 1÷3 cm³ of wax mixed with 2÷4% by weight of 3-methyl butyric acid.

5. A kit according to claim 2, characterized in that the mixture of fragrance carriers (2) there are fibers (3) of dog hair and human hair, preferably in the ratio of 2.5 dkg of dog hair, 1 dkg of human hair and 2 cm³ of wax, preferably paraffin or stearic mixed in 2% by weight with capsaicin.

6. A kit according to claim 2, characterized in that the mixture of fragrance carriers (2) contains 1÷3 cm³ of wax mixed with 2÷4% by weight of 3-methyl butyric acid.
